(19) United States
(12) Patent Application Publication
(10) Pub. No.: US 2019/0370863 A1
(43) Pub. Date: Dec. 5, 2019

(54) VEHICLE TERMINAL AND OPERATION METHOD THEREOF

(71) Applicant: LG Electronics Inc., Seoul (KR)

(72) Inventors: Jin SEO, Seoul (KR); Sangmi SHIN, Seoul (KR)

(21) Appl. No.: 16/545,838

(22) Filed: Aug. 20, 2019

(30) Foreign Application Priority Data
Jul. 10, 2019 (KR) 10-2019-0083075

(51) Int. Cl. G06Q 30/02; H04W 4/44; G09F 21/06; G09F 21/04

(52) U.S. Cl. CPC G06Q 30/0266; G09F 21/048; G09F 21/06; H04W 4/44

(57) ABSTRACT

Disclosed is a method of determining whether a vehicle is suitable for providing an advertisement and identifying an advertising vehicle suitable for providing the advertisement among at least one nearby vehicle and a vehicle terminal for the same. One or more of a vehicle, a vehicle terminal and a self-driving vehicle disclosed in the present invention may operate in conjunction with an Artificial Intelligence (AI) module, an Unmanned Aerial Vehicle (UAV), a robot, an Augmented Reality (AR) device, a Virtual Reality (VR) device, a 5G service-related device, etc.

### CROSS-REFERENCE TO RELATED APPLICATION

This application claims the benefit of Korean Patent Application No. 10-2019-0083075, filed on Jul. 10, 2019, the disclosure of which is incorporated herein in its entirety by reference.

### BACKGROUND

### Field of the invention

The present disclosure relates to a vehicle terminal and an operation method thereof, and more particularly to a vehicle terminal and operation method thereof, the vehicle which identifies an advertising vehicle that is suitable for providing an advertisement.

### Related Art

Attentions are growing on targeted advertising which is providing an advertisement to a specific target through a display of a vehicle, and there is need for more effectively providing targeted advertising.

In addition, a self-driving vehicle refers to a vehicle equipped with an autonomous driving apparatus capable of recognizing a surrounding environment of the vehicle and a vehicle state to thereby controlling driving of the vehicle. Along with researches on the self-driving vehicle, researches on various services for improving user convenience with the self-driving vehicle are being conducted as well.

### SUMMARY

Provided are a vehicle terminal and an operation method thereof. The technical problems of the present disclosure are not limited to the aforementioned technical features, and other unstated technical problems may be inferred from embodiments below.

In one general aspect of the present invention, an operation method of a terminal included in a vehicle includes: receiving an advertising request for asking provision of an advertisement to an advertising target from a server; determining whether the vehicle is suitable for providing the advertisement in response to the advertising request; based on a determination, identifying an advertising vehicle suitable for providing the advertisement to the advertising target among at least one nearby vehicle; and providing information on the advertising vehicle to the server.

In another general aspect of the present invention, a method for providing an advertisement to an advertising target includes: transmitting, by a server, an advertising request for asking provision to the advertisement to the advertising target to a first vehicle; determining, by the first vehicle, whether the first vehicle is suitable for providing the advertisement in response to the advertising request; based on a determination, identifying, by the first vehicle, a second vehicle that is suitable for providing the advertisement to the advertising target; transmitting, by the first vehicle, information on the second vehicle to the server; transmitting, by the server, information on the advertisement to the second vehicle; and providing, by the second vehicle, the advertisement according to the information on the advertisement.

In yet another general aspect of the present invention, a terminal included in a vehicle includes: a communication unit; and a controller configured to receive an advertising request for asking provision of an advertisement to an advertising target from a server through the communication unit, determine whether the vehicle is suitable for providing the advertisement in response to the advertising request, based on a determination, identify an advertising vehicle suitable for providing the advertisement to the advertising target among at least one nearby vehicle, and provide information on the advertising vehicle to the server through the communication unit.

In yet another general aspect of the present invention, a computer readable non-volatile recording medium according to yet another embodiment of the present invention includes a non-volatile recording medium which records a program for implementing the aforementioned method.

Details of other embodiments are included in the detailed description and the attached drawings.

According to embodiments of the present invention, there are one or more advantageous effects as below.

First, according to the present disclosure, when a vehicle requested to provide targeted advertising is not suitable for providing the targeted advertising, the vehicle may identify an advertising vehicle which is to provide the targeted advertising on behalf of the vehicle and therefore it is possible to provide the targeted advertising through the advertising vehicle, thereby improving utility and efficiency of the targeted advertising. On the contrary, when the vehicle requested to provide the targeted advertising is not suitable for providing the targeted advertising, the vehicle may identify an advertising vehicle which is to provide the target advertising together with the vehicle and therefore it is possible to provide the targeted advertising through the vehicle and the advertising vehicle, thereby improving utility and efficiency of the targeted advertising.

Second, according to the present disclosure, not just only a vehicle subscribed to a server for providing targeted advertising, but also an advertising vehicle not subscribed to the server is capable of providing the targeted advertising, thereby diversifying the availability of the target advertising.

Third, according to the present disclosure, revenue from target advertising may be distributed both to the vehicle requested to provide the target advertising and the advertising vehicle actually provided the target advertising, thereby increasing profitability.

Effects of the present invention are not limited to the above disclosed effects, and other effects of the present invention which are not disclosed herein will be clearly understood from the accompanying claims by those skilled in the art.

### BRIEF DESCRIPTION OF THE DRAWINGS

FIG. 1 shows an artificial intelligence (AI) device according to an embodiment of the present invention.

FIG. 2 shows an AI server according to an embodiment of the present invention.

FIG. 3 shows an AI system according to an embodiment of the present invention.

FIG. 4 shows an embodiment in which a terminal included in a vehicle operates.

FIG. 5 shows a flowchart of an operation method of a terminal included in a vehicle.

FIG. 6 is a flowchart in which a second vehicle provides an advertisement to an advertising target on behalf of a first vehicle.

FIG. 7 shows an embodiment of providing an advertisement to an advertising target through an advertising vehicle.

FIG. 8 shows an embodiment of providing an advertisement to advertising targets through multiple advertising vehicles.

FIG. 9 shows another embodiment of providing an advertisement to an advertising target through an advertising vehicle.

FIG. 10 is a flowchart in which a first vehicle and a second vehicle provides an advertisement to an advertising target.

FIGS. 11 and 12 shows embodiments in which a vehicle provides an advertisement together with an advertising vehicle to an advertising target.

FIG. 13 is an embodiment in which a vehicle provides an advertisement together with an advertising vehicle to an advertising target.

FIG. 14 is a block diagram of a vehicle terminal.

### DETAILED DESCRIPTION

Embodiments of the disclosure will be described hereinbelow with reference to the accompanying drawings. However, the embodiments of the disclosure are not limited to the specific embodiments and should be construed as including all modifications, changes, equivalent devices and methods, and/or alternative embodiments of the present disclosure. In the description of the drawings, similar reference numerals are used for similar elements.

The terms “have,” “may have,” “include,” and “may include” as used herein indicate the presence of corresponding features (for example, elements such as numerical values, functions, operations, or parts), and do not preclude the presence of additional features.

The terms “A or B,” “at least one of A or/and B,” or “one or more of A or/and B” as used herein include all possible combinations of items enumerated with them. For example, “A or B,” “at least one of A and B,” or “at least one of A or B” means (1) including at least one A, (2) including at least one B, or (3) including both at least one A and at least one B.

The terms such as “first” and “second” as used herein may use corresponding components regardless of importance or an order and are used to distinguish a component from another without limiting the components. These terms may be used for the purpose of distinguishing one element from another element. For example, a first user device and a second user device may indicate different user devices regardless of the order or importance. For example, a first element may be referred to as a second element without departing from the scope the disclosure, and similarly, a second element may be referred to as a first element.

It will be understood that, when an element (for example, a first element) is “(operatively or communicatively) coupled with/to” or “connected to” another element (for example, a second element), the element may be directly coupled with/to another element, and there may be an intervening element (for example, a third element) between the element and another element. To the contrary, it will be understood that, when an element (for example, a first element) is “directly coupled with/to” or “directly connected to” another element (for example, a second element), there is no intervening element (for example, a third element) between the element and another element.

The expression “configured to (or set to)” as used herein may be used interchangeably with “suitable for,” “having the capacity to,” “designed to,” “ adapted to,” “made to,” or “capable of” according to a context. The term “configured to (set to)” does not necessarily mean “specifically designed to” in a hardware level. Instead, the expression “apparatus configured to . . . ” may mean that the apparatus is “capable of . . . ” along with other devices or parts in a certain context. For example, “a processor configured to (set to) perform A, B, and C” may mean a dedicated processor (e.g., an embedded processor) for performing a corresponding operation, or a generic-purpose processor (e.g., a central processing unit (CPU) or an application processor (AP)) capable of performing a corresponding operation by executing one or more software programs stored in a memory device.

Artificial Intelligence refers to the field of studying artificial intelligence or a methodology capable of making the artificial intelligence. Machine learning refers to the field of studying methodologies that define and solve various problems handled in the field of artificial intelligence. Machine learning is also defined as an algorithm that enhances the performance of a task through a steady experience with respect to the task.

An artificial neural network (ANN) is a model used in machine learning, and may refer to a general model that is composed of artificial neurons (nodes) forming a network by synaptic connection and has problem solving ability. The artificial neural network may be defined by a connection pattern between neurons of different layers, a learning process of updating model parameters, and an activation function of generating an output value.

The artificial neural network may include an input layer and an output layer, and may selectively include one or more hidden layers. Each layer may include one or more neurons, and the artificial neural network may include a synapse that interconnects neurons. In the artificial neural network, each neuron may output input signals that are input through the synapse, weights, and the value of an activation function concerning deflection.

Model parameters refer to parameters determined by learning, and include weights for synaptic connection and deflection of neurons, for example. Then, hyper-parameters mean parameters to be set before learning in a machine learning algorithm, and include a learning rate, the number of repetitions, the size of a mini-batch, and an initialization function, for example.

It can be said that the purpose of learning of the artificial neural network is to determine a model parameter that minimizes a loss function. The loss function maybe used as an index for determining an optimal model parameter in a learning process of the artificial neural network.

Machine learning may be classified, according to a learning method, into supervised learning, unsupervised learning, and reinforcement learning.

The supervised learning refers to a learning method for an artificial neural network in the state in which a label for learning data is given. The label may refer to a correct answer (or a result value) to be deduced by an artificial neural network when learning data is input to the artificial neural network. The unsupervised learning may refer to a learning method for an artificial neural network in the state in which no label for learning data is given. The reinforcement learning may mean a learning method in which an agent defined in a certain environment learns to select a behavior or a behavior sequence that maximizes cumulative compensation in each state.

Machine learning realized by a deep neural network (DNN) including multiple hidden layers among artificial neural networks is also called deep learning, and deep learning is a part of machine learning. Hereinafter, machine learning is used as a meaning including deep learning.

The term “autonomous driving” refers to a technology of autonomous driving, and the term “autonomous vehicle” refers to a vehicle that travels without a user's operation or with a user's minimum operation.

For example, autonomous driving may include all of a technology of maintaining the lane in which a vehicle is driving, a technology of automatically adjusting a vehicle speed such as adaptive cruise control, a technology of causing a vehicle to automatically drive along a given route, and a technology of automatically setting a route, along which a vehicle drives, when a destination is set.

A vehicle may include all of a vehicle having only an internal combustion engine, a hybrid vehicle having both an internal combustion engine and an electric motor, and an electric vehicle having only an electric motor, and may be meant to include not only an automobile but also a train and a motorcycle, for example.

At this time, an autonomous vehicle may be seen as a robot having an autonomous driving function.

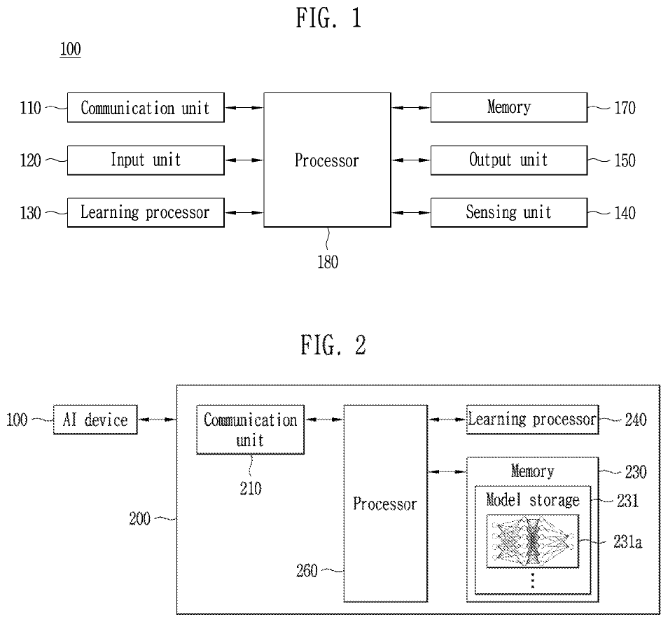

FIG. 1 illustrates an AI device 100 according to an embodiment of the present disclosure.

AI device 100 may be realized into, for example, a stationary appliance or a movable appliance, such as a TV, a projector, a cellular phone, a smart phone, a desktop computer, a laptop computer, a digital broadcasting terminal, a personal digital assistant (PDA), a portable multimedia player (PMP), a navigation system, a tablet PC, a wearable device, a set-top box (STB), a DMB receiver, a radio, a washing machine, a refrigerator, a digital signage, a robot, or a vehicle.

Referring to FIG. 1, Terminal 100 may include a communication unit 110, an input unit 120, a learning processor 130, a sensing unit 140, an output unit 150, a memory 170, and a processor 180, for example.

Communication unit 110 may transmit and receive data to and from external devices, such as other AI devices 100a to 100e and an AI server 200, using wired/wireless communication technologies. For example, communication unit 110 may transmit and receive sensor information, user input, learning models, and control signals, for example, to and from external devices.

At this time, the communication technology used by communication unit 110 may be, for example, a global system for mobile communication (GSM), code division multiple Access (CDMA), long term evolution (LTE), 5G, wireless LAN (WLAN), wireless-fidelity (Wi-Fi), bluetooth™, radio frequency identification (RFID), infrared data association (IrDA), ZigBee, or near field communication (NFC).

Input unit 120 may acquire various types of data.

At this time, input unit 120 may include a camera for the input of an image signal, a microphone for receiving an audio signal, and a user input unit for receiving information input by a user, for example. Here, the camera or the microphone may be handled as a sensor, and a signal acquired from the camera or the microphone may be referred to as sensing data or sensor information.

Input unit 120 may acquire, for example, input data to be used when acquiring an output using learning data for model learning and a learning model. Input unit 120 may acquire unprocessed input data, and in this case, processor 180 or learning processor 130 may extract an input feature as pre-processing for the input data.

Learning processor 130 may cause a model configured with an artificial neural network to learn using the learning data. Here, the learned artificial neural network may be called a learning model. The learning model may be used to deduce a result value for newly input data other than the learning data, and the deduced value may be used as a determination base for performing any operation.

At this time, learning processor 130 may perform AI processing along with a learning processor 240 of AI server 200.

At this time, learning processor 130 may include a memory integrated or embodied in AI device 100. Alternatively, learning processor 130 may be realized using memory 170, an external memory directly coupled to AI device 100, or a memory held in an external device.

Sensing unit 140 may acquire at least one of internal information of AI device 100 and surrounding environmental information and user information of AI device 100 using various sensors.

At this time, the sensors included in sensing unit 140 may be a proximity sensor, an illuminance sensor, an acceleration sensor, a magnetic sensor, a gyro sensor, an inertial sensor, an RGB sensor, an IR sensor, a fingerprint recognition sensor, an ultrasonic sensor, an optical sensor, a microphone, a lidar, and a radar, for example.

Output unit 150 may generate, for example, a visual output, an auditory output, or a tactile output.

At this time, output unit 150 may include, for example, a display that outputs visual information, a speaker that outputs auditory information, and a haptic module that outputs tactile information.

Memory 170 may store data which assists various functions of AI device 100. For example, memory 170 may store input data acquired by input unit 120, learning data, learning models, and learning history, for example.

Processor 180 may determine at least one executable operation of AI device 100 based on information determined or generated using a data analysis algorithm or a machine learning algorithm. Then, processor 180 may control constituent elements of AI device 100 to perform the determined operation.

To this end, processor 180 may request, search, receive, or utilize data of learning processor 130 or memory 170, and may control the constituent elements of AI device 100 so as to execute a predictable operation or an operation that is deemed desirable among the at least one executable operation.

At this time, when connection of an external device is necessary to perform the determined operation, processor 180 may generate a control signal for controlling the external device and may transmit the generated control signal to the external device.

Processor 180 may acquire intention information with respect to user input and may determine a user request based on the acquired intention information.

At this time, processor 180 may acquire intention information corresponding to the user input using at least one of a speech to text (STT) engine for converting voice input into a character string and a natural language processing (NLP) engine for acquiring natural language intention information.

At this time, at least a part of the STT engine and/or the NLP engine may be configured with an artificial neural network learned according to a machine learning algorithm. Then, the STT engine and/or the NLP engine may have learned by learning processor 130, may have learned by learning processor 240 of AI server 200, or may have learned by distributed processing of processors 130 and 240.

Processor 180 may collect history information including, for example, the content of an operation of AI device 100 or feedback of the user with respect to an operation, and may store the collected information in memory 170 or learning processor 130, or may transmit the collected information to an external device such as AI server 200. The collected history information may be used to update a learning model.

Processor 180 may control at least some of the constituent elements of AI device 100 in order to drive an application program stored in memory 170. Moreover, processor 180 may combine and operate two or more of the constituent elements of AI device 100 for the driving of the application program.

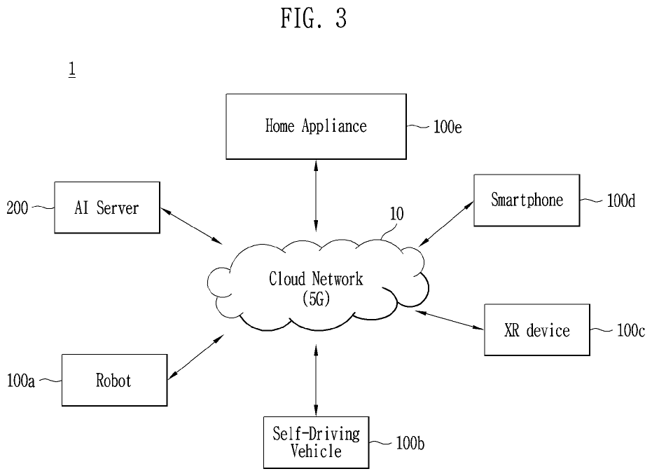

FIG. 2 illustrates AI server 200 according to an embodiment of the present disclosure.

Referring to FIG. 2, AI server 200 may refer to a device that causes an artificial neural network to learn using a machine learning algorithm or uses the learned artificial neural network. Here, AI server 200 may be constituted of multiple servers to perform distributed processing, and may be defined as a 5G network. At this time, AI server 200 may be included as a constituent element of AI device 100 so as to perform at least a part of AI processing together with AI device 100.

AI server 200 may include a communication unit 210, a memory 230, a learning processor 240, and a processor 260, for example.

Communication unit 210 may transmit and receive data to and from an external device such as AI device 100.

Memory 230 may include a model storage unit 231. Model storage unit 231 may store a model (or an artificial neural network) 231a which is learning or has learned via learning processor 240.

Learning processor 240 may cause artificial neural network 231a to learn learning data. A learning model may be used in the state of being mounted in AI server 200 of the artificial neural network, or may be used in the state of being mounted in an external device such as AI device 100.

The learning model may be realized in hardware, software, or a combination of hardware and software. In the case in which a part or the entirety of the learning model is realized in software, one or more instructions constituting the learning model may be stored in memory 230.

Processor 260 may deduce a result value for newly input data using the learning model, and may generate a response or a control instruction based on the deduced result value.

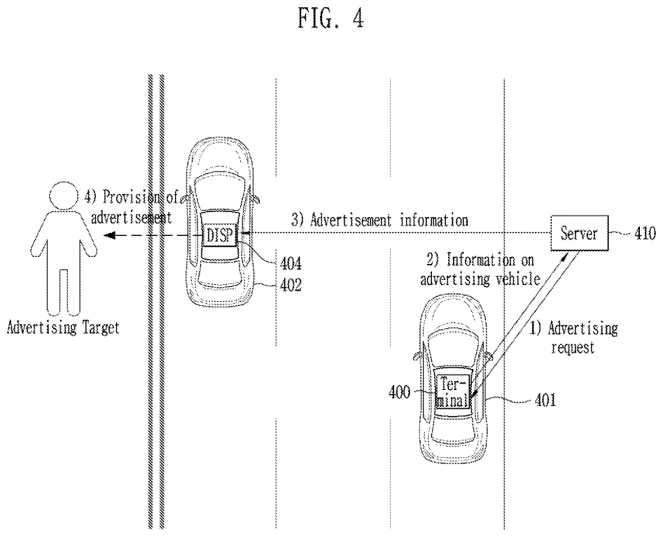

FIG. 3 illustrates an AI system 1 according to an embodiment of the present disclosure.

Referring to FIG. 3, in AI system 1, at least one of AI server 200, a robot 100a, an autonomous driving vehicle 100b, an XR device 100c, a smart phone 100d, and a home appliance 100e is connected to a cloud network 10. Here, robot 100a, autonomous driving vehicle 100b, XR device 100c, smart phone 100d, and home appliance 100e, to which AI technologies are applied, may be referred to as AI devices 100a to 100e.

Cloud network 10 may constitute a part of a cloud computing infra-structure, or may mean a network present in the cloud computing infra-structure. Here, cloud network 10 may be configured using a 3G network, a 4G or long term evolution (LTE) network, or a 5G network, for example.

That is, respective devices 100a to 100e and 200 constituting AI system 1 may be connected to each other via cloud network 10. In particular, respective devices 100a to 100e and 200 may communicate with each other via a base station, or may perform direct communication without the base station.

AI server 200 may include a server which performs AI processing and a server which performs an operation with respect to big data.

AI server 200 may be connected to at least one of robot 100a, autonomous driving vehicle 100b, XR device 100c, smart phone 100d, and home appliance 100e, which are AI devices constituting AI system 1, via cloud network 10, and may assist at least a part of AI processing of connected AI devices 100a to 100e.

At this time, instead of AI devices 100a to 100e, AI server 200 may cause an artificial neural network to learn according to a machine learning algorithm, and may directly store a learning model or may transmit the learning model to AI devices 100a to 100e.

At this time, AI server 200 may receive input data from AI devices 100a to 100e, may deduce a result value for the received input data using the learning model, and may generate a response or a control instruction based on the deduced result value to transmit the response or the control instruction to AI devices 100a to 100e.

Alternatively, AI devices 100a to 100e may directly deduce a result value with respect to input data using the learning model, and may generate a response or a control instruction based on the deduced result value.

Hereinafter, various embodiments of AI devices 100a to 100e, to which the above-described technology is applied, will be described. Here, AI devices 100a to 100e illustrated in FIG. 3 may be specific embodiments of AI device 100 illustrated in FIG. 1.

Autonomous driving vehicle 100b may be realized into a mobile robot, a vehicle, or an unmanned air vehicle, for example, through the application of AI technologies.

Autonomous driving vehicle 100b may include an autonomous driving control module for controlling an autonomous driving function, and the autonomous driving control module may mean a software module or a chip realized in hardware. The autonomous driving control module may be a constituent element included in autonomous driving vehicle 100b, but may be a separate hardware element outside autonomous driving vehicle 100b so as to be connected to autonomous driving vehicle 100b.

Autonomous driving vehicle 100b may acquire information on the state of autonomous driving vehicle 100b using sensor information acquired from various types of sensors, may detect (recognize) the surrounding environment and an object, may generate map data, may determine a movement route and a driving plan, or may determine an operation.

Here, autonomous driving vehicle 100b may use sensor information acquired from at least one sensor among a lidar, a radar, and a camera in the same manner as robot 100a in order to determine a movement route and a driving plan.

In particular, autonomous driving vehicle 100b may recognize the environment or an object with respect to an area outside the field of vision or an area located at a predetermined distance or more by receiving sensor information from external devices, or may directly receive recognized information from external devices.

Autonomous driving vehicle 100b may perform the above-described operations using a learning model configured with at least one artificial neural network. For example, autonomous driving vehicle 100b may recognize the surrounding environment and the object using the learning model, and may determine a driving line using the recognized surrounding environment information or object information. Here, the learning model may be directly learned in autonomous driving vehicle 100b, or may be learned in an external device such as AI server 200.

At this time, autonomous driving vehicle 100b may generate a result using the learning model to perform an operation, but may transmit sensor information to an external device such as AI server 200 and receive a result generated by the external device to perform an operation.

Autonomous driving vehicle 100b may determine a movement route and a driving plan using at least one of map data, object information detected from sensor information, and object information acquired from an external device, and a drive unit may be controlled to drive autonomous driving vehicle 100b according to the determined movement route and driving plan.

The map data may include object identification information for various objects arranged in a space (e.g., a road) along which autonomous driving vehicle 100b drives. For example, the map data may include object identification information for stationary objects, such as streetlights, rocks, and buildings, and movable objects such as vehicles and pedestrians. Then, the object identification information may include names, types, distances, and locations, for example.

In addition, autonomous driving vehicle 100b may perform an operation or may drive by controlling the drive unit based on user control or interaction. At this time, autonomous driving vehicle 100b may acquire interactional intention information depending on a user operation or voice expression, and may determine a response based on the acquired intention information to perform an operation.

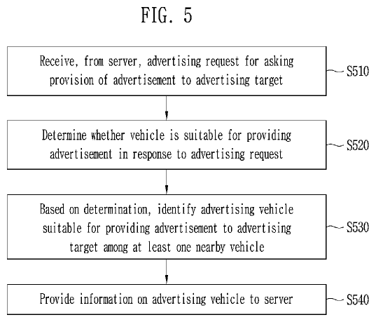

FIG. 4 shows an embodiment in which a terminal included in a vehicle operates.

A terminal 400 may be included in a vehicle 401.

The terminal 400 may receive, from a server 410, an advertise request for asking provision of an advertisement to an advertising target. In other words, the server 410 may request provision of a targeted advertisement from the terminal 400.

The terminal 400 may determine whether the vehicle 401 is suitable for providing an advertisement in response to an advertising request. In other words, the terminal 400 may determine whether or not the vehicle 402 is a vehicle capable of effectively providing the advertisement in response to an advertising request. For example, the terminal 400 may determine that the vehicle 401 is not suitable for providing the advertisement in response to an advertising request when the vehicle 401 is at a long distance from an advertising target or an obstacle exists between the vehicle 401 and the advertising target.

When it is determined that the vehicle 401 is not suitable for providing an advertisement to an advertising target, the terminal 400 may determine an advertising vehicle suitable for providing the advertisement to the advertising target. Specifically, the terminal 400 may identify a vehicle 402 closely located to the advertising target in FIG. 4 as an advertising vehicle.

The terminal 400 may transmit information on the vehicle 402, which is an advertising vehicle, to the server 410. Then, the server 410 may transmit information on an advertisement to the vehicle 402, and the vehicle 402 may provide the advertisement to a targeted audience through a display DISP 404 included in the vehicle 402. The display DISP 404 may be disposed on an upper portion of the vehicle 402 or may be formed in at least one of a right window, a left window, or a rear window of the vehicle 402. Shape of the display DISP 404 included in the vehicle 402 is not limited thereto.

The server 410 may distribute advertising revenue to both the vehicle 401, which has received the advertising request, and the vehicle 402, which has provided the advertisement.

According to the present disclosure, when the vehicle 401 requested to provide targeted advertising is not suitable for providing targeted advertising, the vehicle 401 may identify the vehicle 402 to provide the targeted advertising on behalf of itself and eventually it is possible to provide the targeted advertising through the vehicle 402, thereby improving utility and effectivity of the targeted advertising. On the contrary, when the vehicle 401 requested to provide the targeted advertising is suitable for providing the targeted advertising, the vehicle 401 may identify the vehicle 402 that is to provide the targeted advertising together with the vehicle 401 and eventually it is possible to provide the targeted advertising through the vehicle 401 and the vehicle 402, thereby improving utility and efficiency of the targeted advertising. In addition, since not just the vehicle 401 subscribed to the server 410 providing the targeted advertising but also the vehicle 402 not subscribed to the server 410 are capable of providing targeted advertising, the availability of the targeted advertising may be diversified. In addition, since the profits from the targeted advertising can be distributed to both the vehicle 401, which has been requested to provide the targeted advertising, and the vehicle 402, which has provided the targeted advertising, thereby increasing profitability.

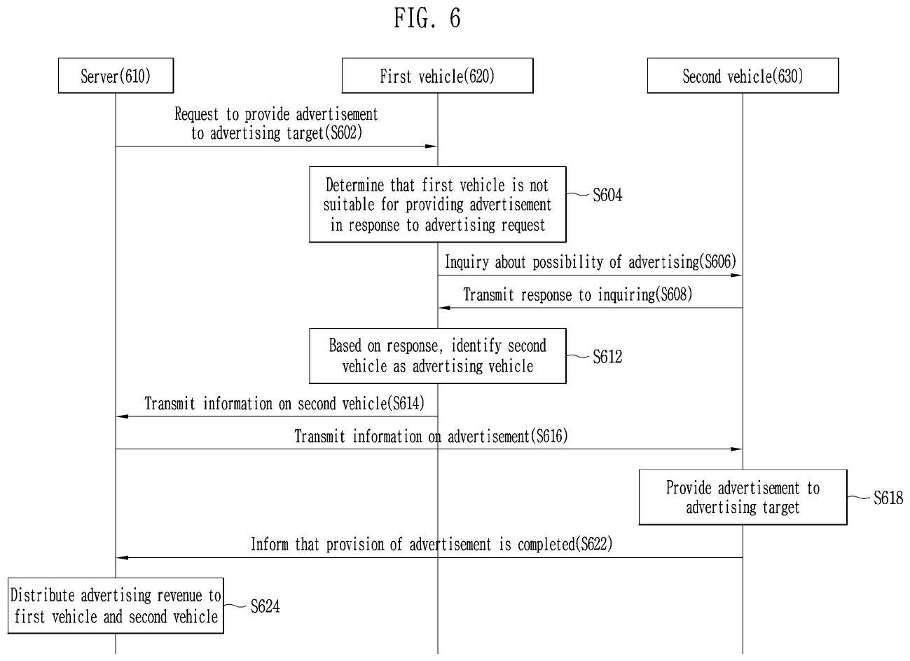

FIG. 5 is a flowchart of an operation method of a terminal included in a vehicle.

The flowchart shown in FIG. 5 consists of operations that are processed in time series by the terminal 400 shown in FIG. 4. Thus, although omitted in the following description, description provided above in regard to operations of the terminal 400 shown in FIG. 4 may apply to the flowchart shown in FIG. 5.

In step s510, the terminal 400 may receive, from a server, an advertising request for provision of an advertisement to an advertising target. The terminal 400 may be included in a vehicle, and the vehicle may be a self-driving vehicle. The vehicle including the terminal 400 may be a vehicle subscribed to an advertisement-related service provided by a server.

The terminal 400 may receive an advertising request from a server through wireless communication between the vehicle and infrastructure (Vehicle to Infrastructure (V2I) communication) and through wireless communication between the vehicle and a network (Vehicle to Network (V2N) wireless communication).

The terminal 400 may receive, from the server, at least one of the following: location information on the advertising target, advertising image information, and information on advertising revenue.

In step s520, the terminal 500 may determine whether the vehicle is suitable for providing an advertisement according to an advertising request. In other words, the terminal 400 may determine whether the vehicle is suitable as a vehicle for effectively providing an advertisement to an advertising target.

The terminal 400 may determine whether the vehicle is suitable for providing an advertisement according to an advertising request, based on information on a surrounding environment of the vehicle. The information on the surrounding environment of the vehicle may include information on at least one of a location, a speed, or a size of a nearby vehicle and may include information on a location and a size of a nearby object. For example, when transmission of an advertisement through a display of the vehicle is interrupted by any nearby vehicle, the terminal may determine that the vehicle is not suitable for providing the advertisement. On the contrary, when transmission of the advertisement through the display of the vehicle is not interrupted by any nearby vehicle, the terminal 400 may determine that the vehicle is suitable for providing the advertisement.

The terminal 400 may determine whether the vehicle is suitable for providing an advertisement in response to an advertising request, based on information on a traveling state of the vehicle. The information on the traveling state of the vehicle may include information on at least one of a location, a driving speed, a driving direction, or a driving path of the vehicle. For example, when there is a long distance between the current driving location of the vehicle and an advertising target, the terminal 400 may determine that the vehicle is not suitable for providing an advertisement. On the contrary, when there is a short distance between the current driving location of the vehicle and the advertising target, the terminal 400 may determine that the vehicle is suitable for providing an advertisement.

The terminal 400 may determine whether the vehicle is suitable for providing an advertisement in response to an advertising request, based on a state of the display of the vehicle. For example, when an advertising target is not located in a direction in which the display of the display faces, the terminal 400 may determine that the vehicle may determine that the vehicle is not suitable for providing an advertisement.

In step s530, the terminal 400 may identify an advertising vehicle suitable for providing an advertisement to an advertising target from among at least one nearby vehicle, based on a determination made in step s520. In one example, when a determination made in step s520 is that the vehicle is not suitable for providing an advertisement, the terminal 400 may identify an advertising vehicle that is to provide the advertisement on behalf of the vehicle. In another example, when a determination made in step s520 is that the vehicle is suitable for providing an advertisement, the terminal 400 may identify an advertising vehicle that is to provide the advertisement together with the vehicle.

The terminal 400 may identify an advertising vehicle based on information on a driving state of at least one nearby vehicle. Information on a driving state of a nearby vehicle may include information on at least one of a location, a speed, or a scheduled driving path of the nearby vehicle. For example, based on locations or speeds of nearby vehicles, the terminal 400 may determine a vehicle nearest to an advertising target among the nearby vehicles as an advertising vehicle. The terminal 500 may acquire information on a driving state of at least one nearby vehicle through communication with the at least one nearby vehicle or through communication with the server.

The terminal 400 may inquire at least one nearby vehicle about a possibility of advertising, and may identify an advertising vehicle based on a response to the inquiring. For example, the terminal 400 may inquire nearby vehicles about a possibility of advertising, and may identify a vehicle giving a positive response to the inquiring as an advertising vehicle.

In step s540, the terminal 400 may provide information on the advertising vehicle identified in step s530 to the server. The information on the advertising vehicle may include at least one of ID of the advertising vehicle, a location of the advertising vehicle, or a state of a display.

Based on the information related to the advertising vehicle provided by the terminal 400, the server may transmit information on an advertisement for an advertising target to the advertising vehicle and the advertising vehicle may provide the advertisement to the advertising target.

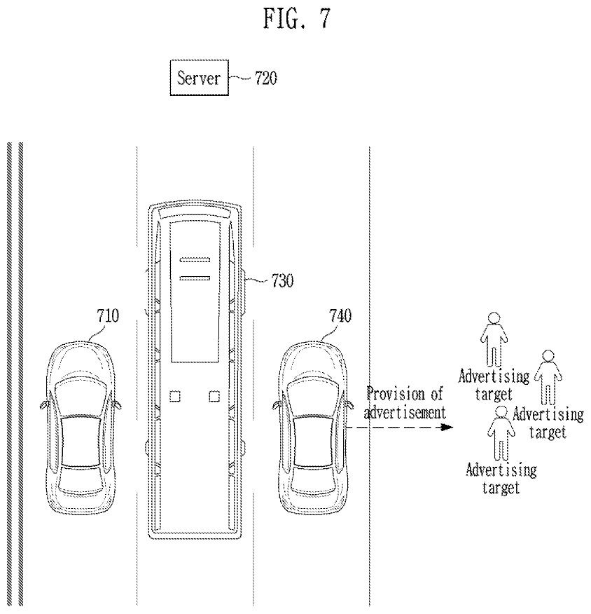

FIG. 6 is a flowchart in which a second vehicle provides an advertisement to an advertising target on behalf of a first vehicle.

In step s602, a server 610 may request a first vehicle 620 to provide an advertisement to an advertising target.

First, the server 610 may collect data from a mobile device, infrastructure, or a vehicle, and may determine, based on the collected data, an advertising target and an advertisement to be transmitted to the advertising target. Specifically, the server 610 may identify advertising targets in a specific area from a mobile device, infrastructure such as a CCTV or a signage camera, or sensors in a vehicle, and may determine an advertisement for a common interest through target segmentation with respect to the advertising targets. For example, the server 610 may determine that 15 out of 20 pedestrians in a specific area are likely to have interest in superhero movies, and may determine an advertisement for Marvel movies.

In an embodiment, the server 610 may transmit, to a first vehicle 620, an advertising request for asking the first vehicle 620 to provide an advertisement to an advertising target. In another embodiment, the server 610 may transmit an advertising request for asking a different vehicle to provide an advertisement to an advertising target on behalf of the first vehicle 620. For example, when there is no vehicle subscribed to a service about an advertisement provided by the server 610 among nearby vehicles for a specific advertising target, the server 610 may transmit an advertising request to the first vehicle 620 subscribed to the service. In this case, the first vehicle 620 may identify an advertising vehicle that is suitable for providing an advertisement to an advertising target among at least one nearby vehicle.

In step s604, the first vehicle 620 may determine that the first vehicle 620 is not suitable for providing an advertisement in response to the advertising request transmitted in step s602. In other words, the first vehicle 620 may determine that the first vehicle 620 is not suitable for effectively providing an advertisement to an advertising target through a display.

In step s606, the first vehicle 620 may inquire a second vehicle 603 about whether the second vehicle 603 is capable of providing an advertisement to the advertising target. In addition, the first vehicle 620 may inquire a different vehicle in addition to the second vehicle 630 about a possibility of advertising.

The first vehicle 620 may inquire the second vehicle 630 about a possibility of advertising, through Vehicle to Vehicle (V2V) wireless communication and through Vehicle to Infrastructure (V2I) wireless communication. In the V2I wireless communication, the first vehicle 620 may first acquire information on the second vehicle 630 from infrastructure.

In step s608, the second vehicle 630 may transmit a response to the inquiring of the first vehicle to the first vehicle 620. Specifically, the second vehicle 630 may transmit, to the first vehicle 620, a response indicating that providing an advertisement to the advertising target is possible. For example, the second vehicle 630 may determine whether the second vehicle 630 is suitable for providing the advertisement to the advertising target, and, when it is determined that the second vehicle 630 is suitable for providing the advertisement to the advertising target, the second vehicle 630 may transmit a positive response to the first vehicle 620.

In step s612, the first vehicle 620 may identify the second vehicle 630 as an advertising vehicle suitable for providing the advertisement to the advertising target, based on the response transmitted in step s608. In addition, when the first vehicle 620 inquires multiple vehicles about a possibility of advertising in step s606 and receives positive responses from the multiple vehicles, the first vehicle 620 may identify an advertising vehicle most suitable for providing the advertisement among the multiple vehicles. For example, the first vehicle 620 may select a vehicle nearest to the advertising target among the multiple vehicles as an advertising vehicle.

In step s614, the first vehicle 620 may transmit information on the second vehicle 630 to the server 610.

In step s616, the server 610 may transmit information on an advertisement to the second vehicle 630. For example, the server 610 may transmit, to the second vehicle 630, information on an IP address from which an advertising image can be downloaded.

In step S618, the second vehicle 630 may provide the advertisement to the advertising target according to the information on the advertisement provided by the server 610. However, if the second vehicle 630 moves out of an area with the advertising target set thereto while providing the advertisement, the second vehicle 630 may sense the deviation and stop providing the advertisement. In addition, the server 610 may sense a state in which the advertising target moves out of the predetermined area and may instruct the second vehicle to stop providing the advertisement. In addition, if there is need for providing different information while the second vehicle 630 provides the advertisement, the server 610 may control the second vehicle 630 to provide the different information. For example, if a notification for a public purpose on an emergency, such as a natural disaster alarm, is necessary, the server 610 may perform control such that the second vehicle 630 stops providing the advertisement and then provides the notification for the public purpose. Alternatively, the server 610 may perform control such that the second vehicle 630 provides both the advertisement and the public-purpose notification at the same time.

The second vehicle 630 may provide an advertisement through a display that is selected according to a type of an advertising target among multiple displays. For example, in a case where the advertising targets are pedestrians, the second vehicle 630 may provide an advertisement through a display formed in an upper side thereof, and, in a case where the advertising targets are occupant present in a nearby vehicle, the second vehicle 630 may provide the advertisement through a display formed in a window thereof. In addition, in a case where the advertising targets are a pedestrian and an occupant, the second vehicle 630 may provide the advertisement to the advertising targets both through a display formed in an upper side of the second vehicle 30 and through a display formed in a window of the second vehicle 630.

In step s622, the second vehicle 640 may inform the server 610 of the fact that provision of the advertisement to the advertising target is completed.

In step s622, the second vehicle 630 may inform the server 610 of the fact that provision of the advertisement to the advertising target is completed.

In step s624, the server 610 may distribute advertising revenues to the first vehicle 620 and the second vehicle 630. For example, the server 610 may set contributions of each of the first vehicle 620 and the second vehicle 630, and distribute advertising revenues according to the set contribution.

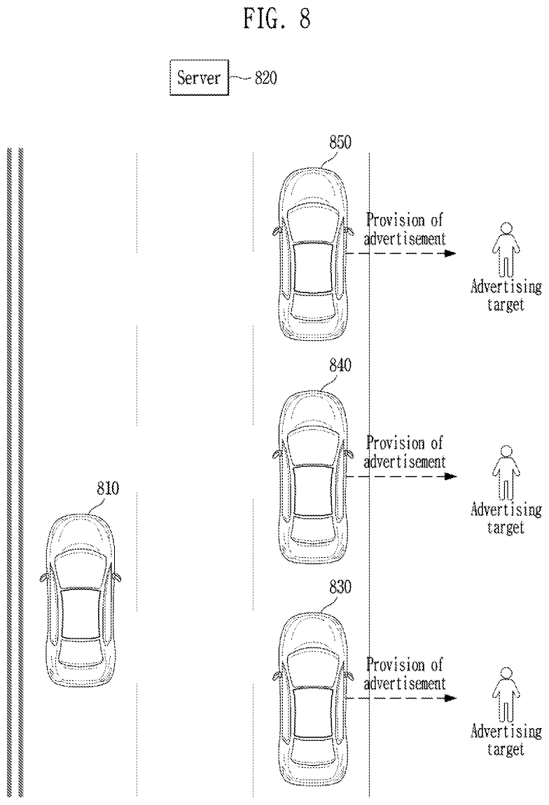

FIG. 7 shows an embodiment of providing an advertisement to an advertising target through an advertising vehicle.

A vehicle 710 may receive, from a server 720, an advertising request for asking provision of an advertisement to advertising targets shown in FIG. 7.

The vehicle 710 may determine whether the vehicle 710 is suitable for providing an advertisement in response to an advertising request from the server 720. Specifically, the vehicle 710 may sense a surrounding environment of the vehicle 710, and may identify the presence of a truck 730 existing between the vehicle 710 and the advertising targets, according to a sensing result. For example, the vehicle 710 may identify the truck 730 through an image sensor in the vehicle 710. The truck 730 may interrupt provision of an advertisement through a display in the vehicle 710, and thus the vehicle 710 may determine that the vehicle 710 is not suitable for providing an advertisement. In addition, the vehicle 710 may acquire information on a driving path or speed of the truck 730 through V2V communication with the truck 730 and may determine, based on the acquired information, that the vehicle 710 is not suitable for providing an advertisement to an advertising target by changing a lane.

Then, the vehicle 710 may identify a vehicle 740 among at least one nearby vehicle in the surroundings of the vehicle 710 as an advertising vehicle suitable for providing an advertisement for advertising targets. Specifically, the vehicle 710 may acquire information on a location of the vehicle 740 through communication with the vehicle 740 and may determine, based on the acquired information, that the vehicle 740 is suitable for providing an advertisement for advertising targets through a display.

The vehicle 710 may transmit information on the vehicle 740, being an advertising vehicle, to the server 740 and the server 720 may transmit information on an advertising image to be provided to the advertising targets to the vehicle 740. Thus, the vehicle 740 may provide an advertisement to the advertising targets by displaying the advertising image through the display.

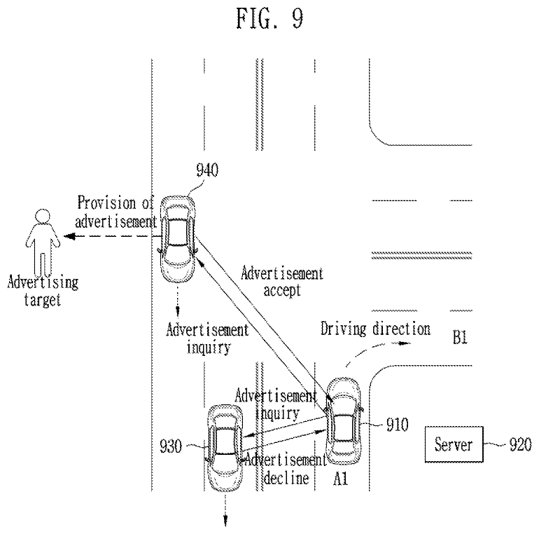

FIG. 8 shows an embodiment of providing an advertisement to advertising targets through multiple advertising vehicles.

A vehicle 810 may receive, from a server 820, an advertising request for asking provision of an advertisement to the advertising targets shown in FIG. 8.

The vehicle 810 may determine whether the vehicle 810 is suitable for providing the advertisement in response to the advertising request from the server 820. Specifically, the vehicle 810 may receive information on a surrounding environment of the vehicle 810 from the server 820 or from navigation of the vehicle 810 and may identify the presence of vehicles 830, 840, and 850 stopped on a fourth lane, based on the received information. The vehicle 810 may acquire map data from the server 820. For example, the vehicle 810 may acquire, from the server 820, information indicating that the fourth lane corresponds to an on-street parking zone, and may identify the stopped vehicles 830, 840, and 850 based on a sensing result for the fourth lane. Thus, the vehicle 810 may determine that the vehicle cannot effectively provide an advertisement to the advertising targets due to the presence of the vehicles 830, 840, and 850 stopped on the fourth lane.

Then, the vehicle 810 may identify the vehicles 830, 840, and 850 among nearby vehicles in the surroundings of the vehicle 810 as vehicles suitable for providing an advertisement to the advertising targets. Specifically, the vehicle 810 may acquire, through communication with the vehicles 830, 840, and 850, information on locations of the vehicles 830, 840, and 850 and information on display states of the vehicles 830, 840, and 850 and may identify, based the acquired information, the vehicles 830, 840, and 850 are suitable for providing an advertisement to the advertising targets through displays.

The vehicle 810 may transit information on the vehicles 830, 840, and 850, being advertising vehicles, to the server 820. The server 820 may transmit information on an advertising image to be provided to the advertising targets to the vehicles 830, 840, and 850. Thus, the vehicles 830, 840, and 850 may respectively provide an advertisement to the advertising targets by displaying the advertising image through the displays.

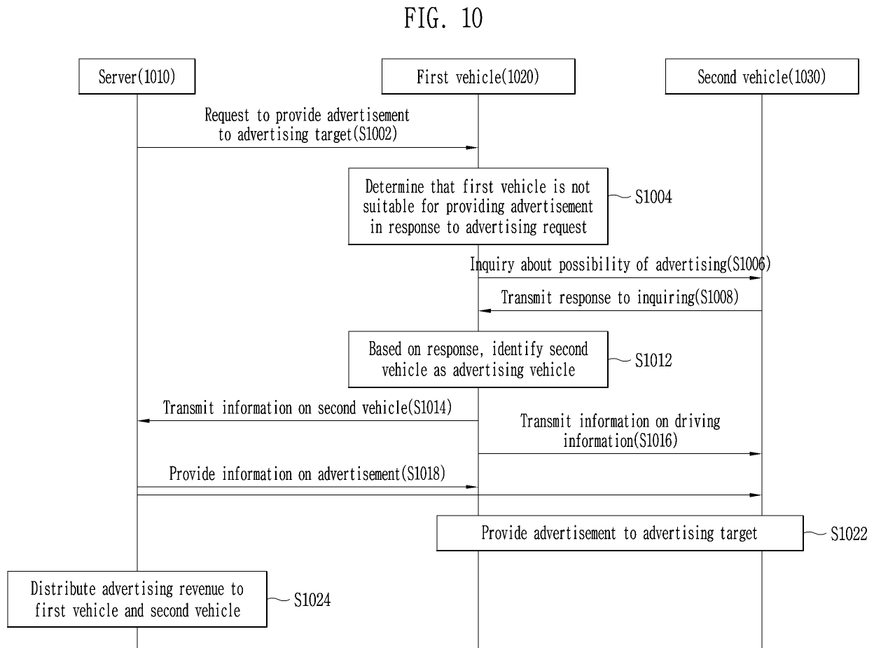

FIG. 9 shows another embodiment of providing an advertisement to an advertising target through an advertising vehicle.

A vehicle 910 may receive, from a server 920, an advertising request for asking provision of an advertisement to an advertising target shown in FIG. 9.

The vehicle 910 may determine whether the vehicle 910 is suitable for providing the advertisement in response to the advertising request from the server 910. Specifically, the vehicle 910 may acquire information on a surrounding environment. For example, the vehicle 910 may sense the surrounding environment through a sensor included in the vehicle 910 and may acquire information on a high definition (HD) map from the server 920. Then, the vehicle 910 may determine whether the vehicle 910 is suitable for providing the advertisement to the advertising target, by taking into consideration of a scheduled driving path of the vehicle 910. As shown in FIG. 9, the scheduled driving path of the vehicle 910 is a path going from lane AI to lane Bl, and thus, the vehicle 910 may determine whether the vehicle 910 is not suitable for providing the advertisement to the advertising target in response to the advertising request from the server 920. In addition, the vehicle 910 may determine that a distance between the vehicle 910 and the advertising target is long and that it is difficult to change a lane near the advertising target due a traffic jam.

The vehicle 910 may inquire nearby vehicles 930 and 940 in the surroundings of the vehicle 910 about a possibility of advertising. Specifically, the vehicle 910 may inquire the nearby vehicles 930 and 940, which are determined to be capable of providing the advertisement to the advertising target among nearby vehicles in the surroundings of the vehicle 910, about a possibility of advertising. Then, the vehicle 910 may receive responses to the inquiring from the vehicles 930 and 940 and identify that the vehicle 940 having transmitted a positive response is an advertising vehicle.

The vehicle 910 may transmit information on the vehicle 940, which is an identified advertising vehicle, to the server. The server 910 may transmit information on an advertising image to be provided to the advertising target to the vehicle 940. Thus, the vehicle 940 may provide the advertisement to the advertising target by displaying the advertising image through a display.

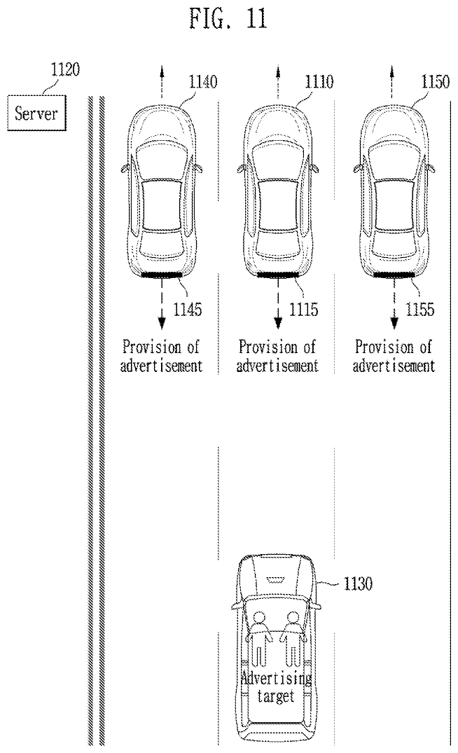

FIG. 10 is a flowchart in which a first vehicle and a second vehicle provides an advertisement to an advertising target.

In step s1002, a server 1010 may request a first vehicle 1020 to provide an advertisement to an advertising target.

In step s1004, the first vehicle 1020 may determine that the first vehicle 1020 is suitable for providing an advertisement in response to the advertising request transmitted in step s1002. In addition, the first vehicle 1020 may determine that the first vehicle 1020 can provide the advertisement together with another vehicle in response to the advertising request. For example, in a case where the advertisement target is a pedestrian and the first vehicle 1020 is traveling in a middle lane in a multi-lane roadway, advertising effect can improve when the advertisement is provided not just by the first vehicle 1020 but also by another vehicle nearby the pedestrian, and thus, the first vehicle 1020 may determine that it is possible to provide the advertisement together with another vehicle near the pedestrian.

In step s1006, the first vehicle 1020 may inquire a second vehicle 1030 about whether it is possible to provide the advertisement to the advertising target. In addition, the first vehicle 1020 may inquire not just the second vehicle 1030 but also another vehicle about a possibility of advertising.

In step s1008, the second vehicle 1030 may transmit a response to the inquiring of the first vehicle 1020 to the first vehicle 1020. Specifically, the second vehicle 1030 may transmit, to the first vehicle 1020, a response indicating that the second vehicle 1030 can provide the advertisement to the advertising target.

In step s1012, the first vehicle 1020 may identify, based on the response received in step s1008, that the second vehicle 1030 is an advertising vehicle suitable for providing the advertisement to the advertising target.

In step s1014, the first vehicle 1020 may transmit information on the second vehicle 1030 to the server 1010.

In step s1016, the first vehicle 1020 may transmit driving information to the second vehicle 1030. Specifically, the first vehicle 1020 may transmit information on a driving location and a driving speed to the second vehicle 1030 to provide the advertisement to the advertising target. For example, when the advertising target is a pedestrian, the first vehicle 1020 may takes into consideration a boarding location of the advertising target, a viewing orientation of the advertising target, and presence of an obstacle blocking a viewing field of the advertising target and determine driving locations and speeds of the first vehicle 1020 and a second vehicle 1030, which are to effectively provide the advertisement to the advertising target. Then, the first vehicle 1020 may share the determined driving locations and speeds with the second vehicle 1030.

In step s1018, the server 1010 may transmit information on the advertisement to the first vehicle 1020 and the second vehicle 1030. For example, the server 1010 may transmit, to the first vehicle 1020 and the second vehicle 1030, information on an IP address from which an advertisement image can be downloaded.

In step s1022, the first vehicle 1020 and the second vehicle 1030 may provide the advertisement to the advertising target according to the information on the advertisement transmitted by the server 1010. Specifically, the first vehicle 120 and the second vehicle 1030 may provide the advertisement to the advertising target through displays by driving according to information on the shared driving locations and speeds. In addition, the first vehicle 1020 and the second vehicle 1030 may display the same advertising image toward the advertising target and, in this case, the first vehicle 1020 or the second vehicle 1030 may partially change the advertising image and display the partially changed advertising image. For example, suppose a case where the advertising target is a pedestrian, where the first vehicle 1020 is driving in a middle lane on a multi-lane roadway, and where the second vehicle 1030 is driving in a lane near the pedestrian. In this case, the second vehicle 1030 may display the entire advertising image whereas the first vehicle 1020 may display the advertising image by enlarging a key part of the advertising image because the first vehicle 1020 is likely to be at a long distance from the advertising target.

In a case where a vehicle in which the advertising vehicle is present deviates from an anticipated path while the first vehicle 1020 and the second vehicle 1030 provide the advertisement, the first vehicle 1020 and the second vehicle 1030 may sense the deviation and stop providing the advertisement. In addition, in a case where the advertising target is sleeping, reading a book, or playing a game and hence cannot look around while the advertisement is provided, the vehicle may sense information on such a state of the advertising target and transmit the information on the state of the advertising target to the server 1010. Then, the server 1010 may control the first vehicle 1020 and the second vehicle 1030 to stop providing the advertisement.

The first vehicle 1020 and the second vehicle 1030 may inform the server 1010 that provision of the advertisement to the advertising target is completed.

In step s1024, the server 1010 may distribute advertising revenue to the first vehicle 1020 and the second vehicle 1030.

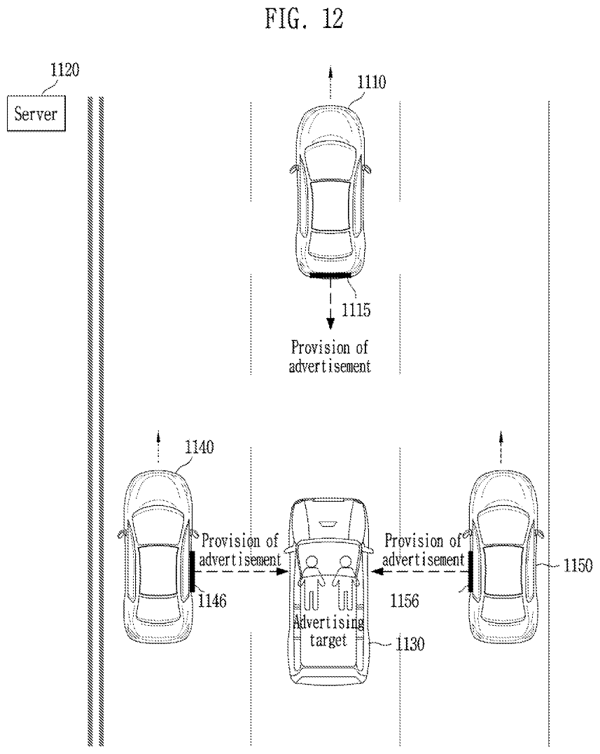

FIGS. 11 and 12 shows embodiments in which a vehicle provides an advertisement together with an advertising vehicle to an advertising target.

A server 1120 may determine that advertising targets are occupants present in all seats of a vehicle 1130 and may request the vehicle 1110 to provide an advertisement to the determined advertising targets.

The vehicle 1110 may determine that the vehicle 1110 is suitable for providing the advertisement to the advertising targets through a rear display 1115 of the vehicle 1110. In addition, in order to effectively provide the advertisement to the advertising targets present in all the seats of the vehicle 1130, the vehicle 1110 may determine to provide the advertisement together with other vehicles located in front of the vehicle 1130.

The vehicle 1110 may inquire a vehicle 1140 and a vehicle 1150 located around the vehicle 1110 about whether it is possible to provide the advertisement to the advertising targets. The vehicle 1110 may receive positive responses to the inquiring from the vehicle 1140 and the vehicle 1150 and may identify the vehicle 1140 and the vehicle 1150 as advertising vehicles.

The vehicle 1110 may transmit information on the vehicle 1140 and the vehicle 1150, which are identified advertising vehicles, to the server 1120. The server 1120 may transmit information on the advertisement to be provided to the advertising targets to the vehicles 1110, 1140, and 1150.

The vehicles 1110, 1140, and 1150 may provide the advertisement to the advertising targets through rear displays 1115, 1145, and 1155, by driving according to information on shared driving locations and speeds.

Referring to FIG. 12, similar to FIG. 11, the vehicles 110 may provide the advertisement to the advertising targets present in all the seats of the vehicle 1130 according to advertisement information provided by the server 1120.

However, in FIG. 12, unlike FIG. 11, the vehicle 1110 may provide the advertisement through the rear display 1115, the vehicle 1140 may provide the advertisement through a display 1146 disposed on a right window, and the vehicle 1150 may provide the advertisement through a display 1156 disposed on a left window. In order to more effectively provide the advertisement to the advertising targets present in all the seats of the vehicle 1130, the vehicle 1110 may determine locations of the vehicles 1110, 1140, and 1150 and displays of the vehicles 1110, 1140, and 1150 and may share the determined locations and displays with the vehicles 1110, 1140, and 1150. In an embodiment, in a case where the vehicle 1130 is a manually driven vehicle, the advertising targets present in the vehicle 1130 have to look forward due to driving, and thus, the vehicles 1110, 1140, and 1150 may provide the advertisement through the locations and displays of the vehicles, as shown in FIG. 11. In another embodiment, in a case where the vehicle 1130 is a self-driving vehicle, the advertising targets are not required to look forward, and thus, the vehicles 1110, 1140, and 150 may provide the advertisement through the locations and displays of the vehicles, as shown in FIG. 12.

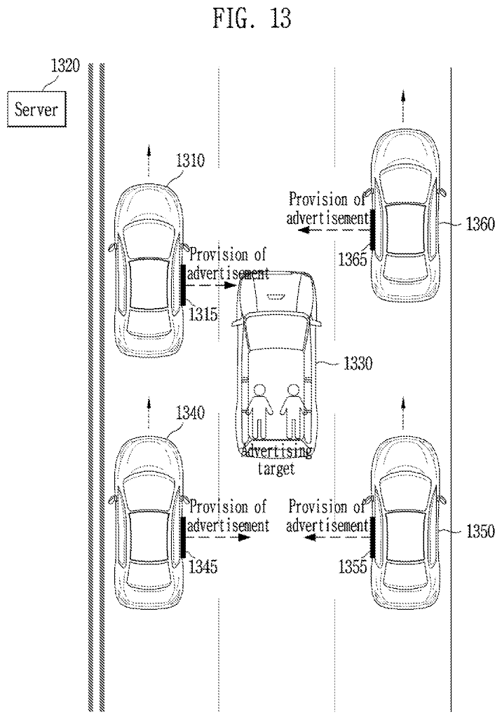

FIG. 13 is an embodiment in which a vehicle provides an advertisement together with an advertising vehicle to an advertising target.

A server 1320 may determine that advertising targets are occupants present in rear seats of a vehicle 11130, and may request a vehicle 1310 to provide an advertisement to the determined advertising targets.

The vehicle 1310 may determine that the vehicle 1310 is suitable for providing the advertisement to the advertising targets through a display 1315 formed in a right window. In addition, in order to effectively provide the advertisement to the advertising targets present in the rear seats of the vehicle 1330, the vehicle 1310 may determine to provide the advertisement together with other vehicles located on the left and right sides of the vehicle 1130.

The vehicle 1310 may inquire vehicles 1340, 1350, and 1360 located around the vehicle 1310 about whether it is possible to provide the advertisement to the advertising targets. The vehicle 1310 may receive positive responses to the inquiring from the vehicles 1340, 1350, and 1350 and may identify the vehicles 1340, 1350, and 1360 as advertising vehicles.

The vehicle 1310 may transmit information on the vehicles 1340, 1350, and 1360, which are identified advertising vehicles, to the server 1320. The server 1320 may transmit information on an advertisement image to be provided to the advertising targets to the vehicles 1310, 1340, and 1350.

The vehicles 1310, 1340, 1350, and 1360 may provide the advertisement to the advertising targets through displays 1315, 1345, 1355, and 1365 by driving according to information on shared driving locations and speeds. Specifically, the vehicles 1310 and 1340 may provide the advertisement to the right through the displays 1315 and 1345 formed in right windows thereof, and the vehicles 1350 and 1360 may provide the advertisement to the left through the displays 1355 and 1365 formed in left windows thereof.

In addition, in a case where the vehicle 1330 is a bus, the advertising targets present in the vehicle 1330 are located at relatively high positions, and thus, the vehicles 1310, 1340, 1350, and 1360 may provide the advertisement through the displays 1315, 1345, 1355, and 1365 located on upper sides of the vehicles 1310, 1340, 1350, and 1360.

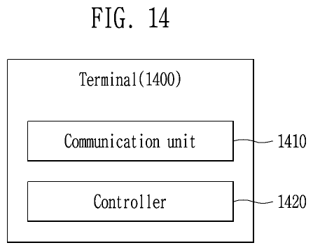

FIG. 14 is a block diagram of a vehicle terminal.

A terminal 1400 may be a device that is disposed in a vehicle to assist driving of the vehicle. According to an embodiment, the terminal 1400 may include a communication unit 1410 and a controller 1420. The terminal 1400 shown in FIG. 14 includes only components related to the present embodiment. Thus, one of ordinary skill in the art may understand that other components other than the components illustrated in FIG. 14 may be further included.

The communication unit 1410 may communicate with an external electronic device. The external electronic device may be a nearby vehicle, a server, or infrastructure such as a Road Side Unit (RSU). The communication unit 1410 may communicate with an external vehicle or a server based on Vehicle to Vehicle (V2V) wireless communication or Vehicle to Network (V2N) wireless communication.

In addition, a communication employed the communication unit 1410 may be Global System for Mobile communication (GSM), Code Division Multi Access (CDMA), Long Term Evolution (LTE), 5G, Wireless LAN (WLAN), Wireless-Fidelity (Wi-Fi), Bluetooth™, Radio Frequency Identification (RFID), Infrared Data Association (IrDA), ZigBee, Near Field Communication (NFC), etc.

The controller 1420 may control overall operations of the terminal 1400 and process data and signals. The controller 1420 may be composed of at least one hardware unit. In addition, the controller 420 may be operated by one or more software modules that is generated upon execution of a program code stored in a memory.

The controller 1420 may receive an advertising request for ask provision of an advertisement to an advertising target from the server through the communication unit 1410.

The controller 1420 may determine whether the vehicle is suitable for providing the advertisement in response to the advertising request. Based on at least one of information on a surrounding environment of the vehicle, information on a driving state of the vehicle, or information on a state of a display of the vehicle, the controller 1420 may determine whether the vehicle is suitable for providing the advertisement in response to the advertising request.

Based on a determination, the controller 1420 may identify an advertising vehicle suitable for providing the advertisement to the advertising target among at least one nearby vehicle.

In one embodiment, when it is determined that the vehicle is not suitable for providing the advertisement to the advertising target, the controller 1420 may identify an advertising vehicle which is to provide the advertisement on behalf of the vehicle. In another embodiment, when it is determined that the vehicle is suitable for providing the advertisement to the advertising target, the controller 1420 may identify an advertising vehicle which is to provide the advertisement together with the vehicle.

The controller 1420 may identify an advertising vehicle based on information on a driving state of at least one nearby vehicle. The controller 1420 may acquire information on a nearby vehicle from the nearby vehicle or the server.

The controller 1420 may inquire, through the communication unit 1410, at least one nearby vehicle about a possibility of advertising and may identify an advertising vehicle based on a response to the inquiring. For example, the controller 1420 may inquire nearby vehicles about a possibility of advertising and may identify that a vehicle having transmitted a positive response to the inquiring is an advertising vehicle.

The controller 1420 may provide information on an advertising vehicle to the server through the communication unit 1410.

The device described above may comprise a processor, a memory for storing program data and executing it, a permanent storage such as a disk drive, a communications port for handling communications with external devices, and user interface devices, including a touch panel, keys, buttons, etc. When software modules or algorithms are involved, these software modules may be stored as program instructions or computer readable codes executable on a processor on a computer-readable recording medium. Examples of the computer readable recording medium include magnetic storage media (e.g., ROM, RAM, floppy disks, hard disks, etc.), and optical recording media (e.g., CD-ROMs, or DVDs). The computer readable recording medium can also be distributed over network coupled computer systems so that the computer readable code is stored and executed in a distributed fashion. This media can be read by the computer, stored in the memory, and executed by the processor.

The present embodiment may be described in terms of functional block components and various processing steps. Such functional blocks may be realized by any number of hardware and/or software components configured to perform the specified functions. For example, the present invention may employ various integrated circuit (IC) components, e.g., memory elements, processing elements, logic elements, look-up tables, and the like, which may carry out a variety of functions under the control of one or more microprocessors or other control devices. Similarly, where the elements of the present invention are implemented using software programming or software elements, the invention may be implemented with any programming or scripting language such as C, C++, Java, assembler, or the like, with the various algorithms being implemented with any combination of data structures, objects, processes, routines or other programming elements. Functional aspects may be implemented in algorithms that are executed on one or more processors. Furthermore, the present invention could employ any number of conventional techniques for electronics configuration, signal processing and/or control, data processing and the like. The words “mechanism”, “element”, “means”, and “configuration” are used broadly and are not limited to mechanical or physical embodiments, but can include software routines in conjunction with processors, etc.

What is claimed is:

1. An operation method of a terminal included in a vehicle, the method comprising;
receiving an advertising request for asking provision of an advertisement to an advertising target from a server;
determining whether the vehicle is suitable for providing the advertisement in response to the advertising request;
based on a determination, identifying an advertising vehicle suitable for providing the advertisement to the advertising target among at least one nearby vehicle; and
providing information on the advertising vehicle to the server.

2. The method of claim 1, wherein the determining comprises determining whether the vehicle is suitable for providing the advertisement in response to the advertising request, based on information on at least one of a surrounding environment of the vehicle, a driving state of the vehicle, or a state of a display of the vehicle.

3. The method of claim 1, wherein the identifying comprises:
when it is determined that the vehicle is not suitable for providing the advertisement in response to the advertising request, identifying an advertising vehicle that is to provide the advertisement on behalf of the vehicle; and
when it is determined that the vehicle is suitable for providing the advertisement in response to the advertising request, identifying an advertising vehicle that is to provide the advertisement together with the vehicle.

4. The method of claim 1, wherein the identifying comprises:
acquiring information on a driving state of the at least one nearby vehicle; and
based on the acquired information, identifying the advertising vehicle among the at least one nearby vehicle.

5. The method of claim 4 wherein the acquiring comprises acquiring the information on the driving state of the at least one nearby vehicle based on Vehicle to Vehicle (V2V) communication or Vehicle to Network (V2N) communication.

6. The method of claim 1, wherein the identifying comprises:
inquiring the at least one nearby vehicle about a possibility of advertising; and
based on a response to the inquiring, identifying the advertising vehicle among the at least one nearby vehicle.

7. A method for providing an advertisement to an advertising target, the method comprising;
transmitting, by a server, an advertising request for asking provision to the advertisement to the advertising target to a first vehicle;
determining, by the first vehicle, whether the first vehicle is suitable for providing the advertisement in response to the advertising request;
based on a determination, identifying, by the first vehicle, a second vehicle that is suitable for providing the advertisement to the advertising target;
transmitting, by the first vehicle, information on the second vehicle to the server;
transmitting, by the server, information on the advertisement to the second vehicle; and
providing, by the second vehicle, the advertisement according to the information on the advertisement.

8. The method of claim 7, further comprising:
when it is determined that the first vehicle is suitable for providing the advertisement in response to the advertising request, identifying, by a first vehicle, a second vehicle that is to provide the advertisement together with the first vehicle,
transmitting, by the server, information on the advertisement to the first vehicle and the second vehicle; and
providing, by the first vehicle and the second vehicle, the advertisement according to the information on the advertisement.

9. The method of claim 7, further comprising distributing, by the server, revenue from the advertisement to the first vehicle and the second vehicle.

10. The method of claim 7, wherein the providing comprises providing the advertisement through a display that is selected from among multiple displays of the second vehicle according to a type of the advertising target.

11. A computer readable non-volatile recording medium which records a program for implementing the method of claim 1 in a computer.

12. A terminal included in a vehicle, the terminal comprising:
a communication unit; and
a controller configured to
receive an advertising request for asking provision of an advertisement to an advertising target from a server through the communication unit,
determine whether the vehicle is suitable for providing the advertisement in response to the advertising request,
based on a determination, identify an advertising vehicle suitable for providing the advertisement to the advertising target among at least one nearby vehicle, and
provide information on the advertising vehicle to the server through the communication unit.

13. The terminal of claim 12, wherein the controller is configured to, based on information on at least one of a surrounding environment of the vehicle, a driving state of the vehicle, or a state of a display of the vehicle, determine whether the vehicle is suitable for providing the advertisement in response to the advertising request.

14. The terminal of claim 12, wherein the controller is configured to:
when it is determined that the vehicle is not suitable for providing the advertisement in response to the advertising request, identify an advertising vehicle that is to provide the advertisement on behalf of the vehicle; and
when it is determined that the vehicle is suitable for providing the advertisement in response to the advertising request, identify an advertising vehicle that is to provide the advertisement together with the vehicle.

15. The terminal of claim 12, wherein the controller is configured to:
acquire information on a driving state of at least one nearby vehicle through the communication unit; and
based on the acquired information, identify the advertising vehicle among the at least one nearby vehicle.

16. The terminal of claim 15, wherein the communication unit is configured to perform Vehicle to Vehicle (V2V) communication or Vehicle to Network (V2N) communication.

17. The terminal of claim 12, wherein the controller is configured to:
inquire the at least one nearby vehicle about a possibility of advertising; and
based on a response to the inquiry, identify the advertising vehicle among the at least one nearby vehicle.
